(19) United States
(12) Patent Application Publication
(10) Pub. No.: US 2005/0284158 A1
(43) Pub. Date: Dec. 29, 2005

(54) Air conditioning system and method for controlling the same

(75) Inventors: Ju Youn Lee, Seoul (KR); Ho Jung Kim, Incheon (KR); Kwan Ho Yum, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/106,677

(22) Filed: Apr. 15, 2005

(30) Foreign Application Priority Data
Jun. 25, 2004 (KR) P2004-0048195

(51) Int. Cl. F24F 7/00; G05D 23/00; F25B 49/00; F25D 23/12; F25D 15/00

(52) U.S. Cl. 62/126; 62/331; 236/49.3; 236/51

(57) ABSTRACT

Air conditioning system and method for controlling the same are disclosed, the air conditioning system including user input means, display means for providing an environmental factor parameter setting up menu, a memory unit for storing the environmental factors, and parameters for the environmental factors, a ventilating fan, an air cleaning fan, and a control unit for calculating an environment index by using parameters of the environment factors set by the user, and controlling the ventilating fan and the air cleaning fan according to the environment index, thereby maximizing a sense of comfortability of the user, and minimizing health hazards such as multiple chemical sensitivity.

### CROSS-REFERENCE TO RELATED APPLICATION

This application claims the benefit of Korean Application No. P2004-0048195 filed on Jun. 25, 2004, which is hereby incorporated by reference as if fully set forth herein.

### BACKGROUND OF THE INVENTION

1. Field of the Invention

The present invention relates to air conditioning systems, and more particularly, to an air conditioning system and a method for controlling the same.

2. Discussion of the Related Art

Most of modern people pass around 80% of their time in room spaces, such as homes, offices, or underground spaces. To the modern people who pass around 80% of their time in such room spaces, a comfortable room environment becomes a very important factor for enhancing efficiency of work, and maintaining their health. Especially, as living standards of the people become the higher, demands for the comfortable room space become the higher.

However, air in an enclosed space becomes to cause uncomfortable feeling as a carbon dioxide content increases by respiration of people in the room, and a heat load of the office increases rapidly due to office automation, and concentration coming from land price rise.

In order to solve the problem of uncomfortable feeling, and to provide a more comfortable environment to the people in the office, an air conditioning system is used, for controlling a temperature, humidity, and so on of the office.

However, there has been a limitation in effective control of the air conditioning system, taking correlation between physical factors, such as a temperature, humidity, an air flow speed, and a radiation of the office, and the human heat senses into account.

According to this, there have been many indices of the human heat sense for quantitative expression of influences of various factors of the human heat sense to a human body, and suggesting a simple, and accurate comfortable range of the human heat sense.

Particularly, of the indices, the New Effective Temperature (ET) used in the USA, of the ASHRAE (American Society of Heating, Refrigerating, and Air-Conditioning Engineers), and the Predicted Mean Vote (PMV), and the Predicted Percentage of Dissatisfied (PPD) adopted as ISO (the International Organization for Standardization) 7730, used in Europe are typical indices for the human heat sense.

The PMV is an index for predicting the human heat sense theoretically obtained by measuring 6 factors of the human heat sense of a human being, and an environment, i.e., an air temperature, a humidity, an air flow speed, a mean radiation temperature, an amount of clothes people put on, and an amount of activity, and substituting measured values for a comfort equation based on a thermal equilibrium of a human body.

The PPD sets up scales of the human heat sense according to the PMV, such as “hot”, “warm”, “slightly warm”, “neutral (0)”, “slightly cool”, “cool”, “cold”, and so on, and represents a predicted percentage of dissatisfied persons for the present environment with the scale of the human heat sense.

FIG. 1 illustrates a graph showing a comfort zone of ISO-7730 according to the PMV and the PPD, wherein it can be noted that the comfort zone falls on ranges satisfying conditions of −0.5<PMV<+0.5, and PPD<10%. That is, by controlling an air conditioning system to meet room temperature and humidity conditions that fall within the ranges of the PMV and the PPD, a better comfortability can be provided to the people in a room.

However, the related art air conditioning system has the following problems.

First, the air conditioning of the related art air conditioning system taking only the room temperature, and humidity into account has a limitation in resolving the uncomfortable feeling and providing comfortability to the user.

Second, the problem of “Sick House Syndrome” becomes greater gradually, in which symptoms of headache, fatigue, dysnea, asthma, rhinitis, cutitis, and so on appear.

The “Sick House Syndrome” is a kind of Multiple Chemical Sensitivity (MCS), in which a specific chemical, or chemicals in room pollutants affect human body compositely. In general, a person showing such symptoms reacts to smells of chemicals from substances in a room environment, such as detergent, perfume, vinyl sheet, very sensitively, to cause serious health hazards.

Actually, furniture, wall paper, tiles, floor paper, carpet, insulating materials, aromatic, asbestos, and so on, and adhesive, paint, and so on used during working contain much volatile organic chemicals, such as formaldehyde, benzene, toluene, xylene, ethyl-benzene, and so on which cause the multiple chemical sensitivity.

However, the related art air conditioning system can not solve the problem of the multiple chemical sensitivity caused by a room environment that contains such volatile organic chemicals.

### SUMMARY OF THE INVENTION

Accordingly, the present invention is directed to an air conditioning system and a method for controlling the same that substantially obviates one or more problems due to limitations and disadvantages of the related art.

An object of the present invention is to provide an air conditioning system and a method for controlling the same, which can solve the problem of the chemical sensitivity, and improve an air conditioning performance taking a residential environment into account to the maximum.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an air conditioning system includes user input means for setting up at least one environmental factor parameter, display means for providing an environmental factor parameter setting up menu, a memory unit for storing the environmental factors, and parameters for the environmental factors, a ventilating fan for ventilating a room, an air cleaning fan for cleaning room air, and a control unit for calculating an environment index by using parameters of the environment factors set by the user, and controlling the ventilating fan and the air cleaning fan according to the environment index.

In another aspect of the present invention, a method for controlling an air conditioning system includes the steps of user setting environmental factor parameters suitable to user's residential environment, calculating an environment index by using the environmental factor parameters, and controlling ventilation and air cleaning operation according to the environment index.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a graph showing a comfort zone of ISO-7730 according to PMV and PPD, indices of human heat sense;

FIG. 2 illustrates a block diagram of an air conditioning system in accordance with a preferred embodiment of the present invention;

FIG. 3 illustrates a lookup table of room environmental factor parameters;

FIG. 4 illustrates a flow chart showing the steps of a method for setting up environmental factor parameters at an air conditioning system in accordance with a preferred embodiment of the present invention;

FIGS. 5A and 5B illustrate diagrams showing examples of menu screens for setting up environmental factor parameters in accordance with a preferred embodiment of the present invention;

FIG. 6 illustrates a diagram showing an example of setting up of room environmental factor parameters with a lookup table in accordance with a preferred embodiment of the present invention; and

FIG. 7 illustrates a flow chart showing the steps of a method for controlling an air conditioning system in accordance with a preferred embodiment of the present invention.

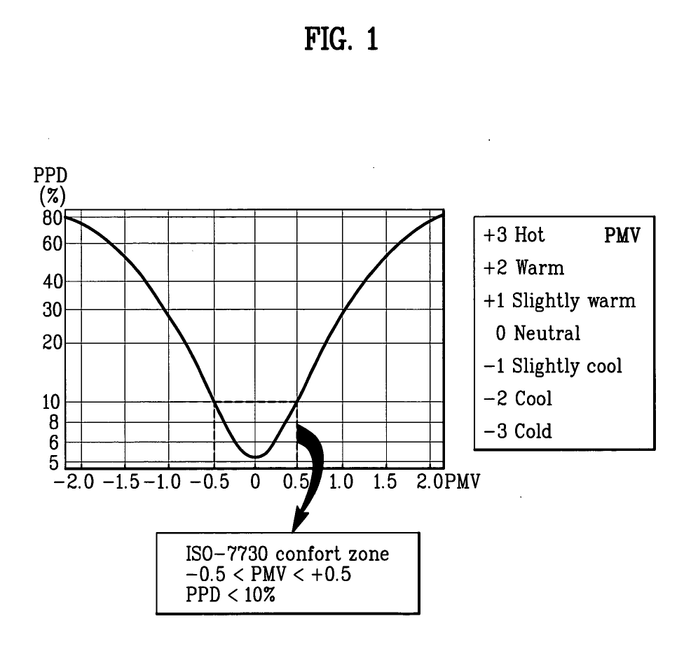

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

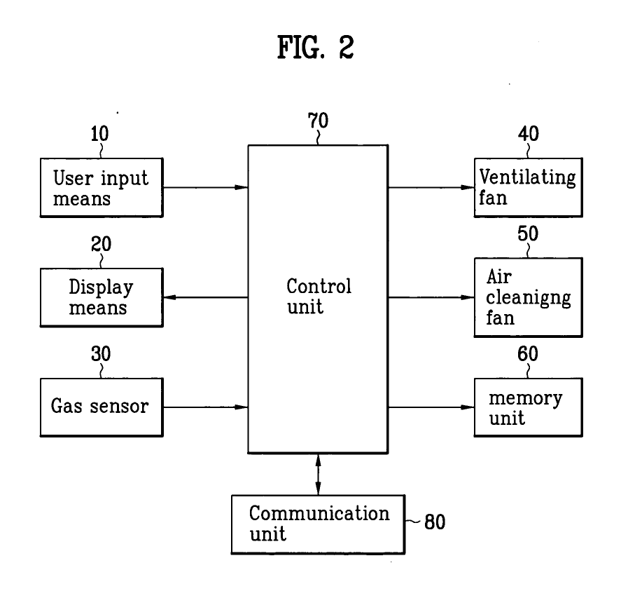

Referring to FIG. 2, the air conditioning system in accordance with a preferred embodiment of the present invention includes user input means 10, display means 20, a gas sensor 30, a ventilating fan 40, an air cleaning fan 50, a memory unit 60, and a control unit 70.

The user input means 10 may be key panel, and a remote controller, for applying environmental factor parameters of user's residential space. The display means 20 may be LCD or the like mounted on a body or a remote controller, for displaying the environmental factor parameter setting up menu.

The gas sensor 30 measures an intensity of smell of the room. The ventilating fan 40 ventilates the room by introducing outdoor air into the room, and discharging room air to outside of the room. The air cleaning fan 50 circulates room air, and cleans the room air with a filter or the like.

The memory unit 60 has a lookup table stored therein. The lookup table contains video information on environmental factor parameter setting up menu display, environmental factor items, detailed items of the environmental factor items, and parameters for each of the detailed items.

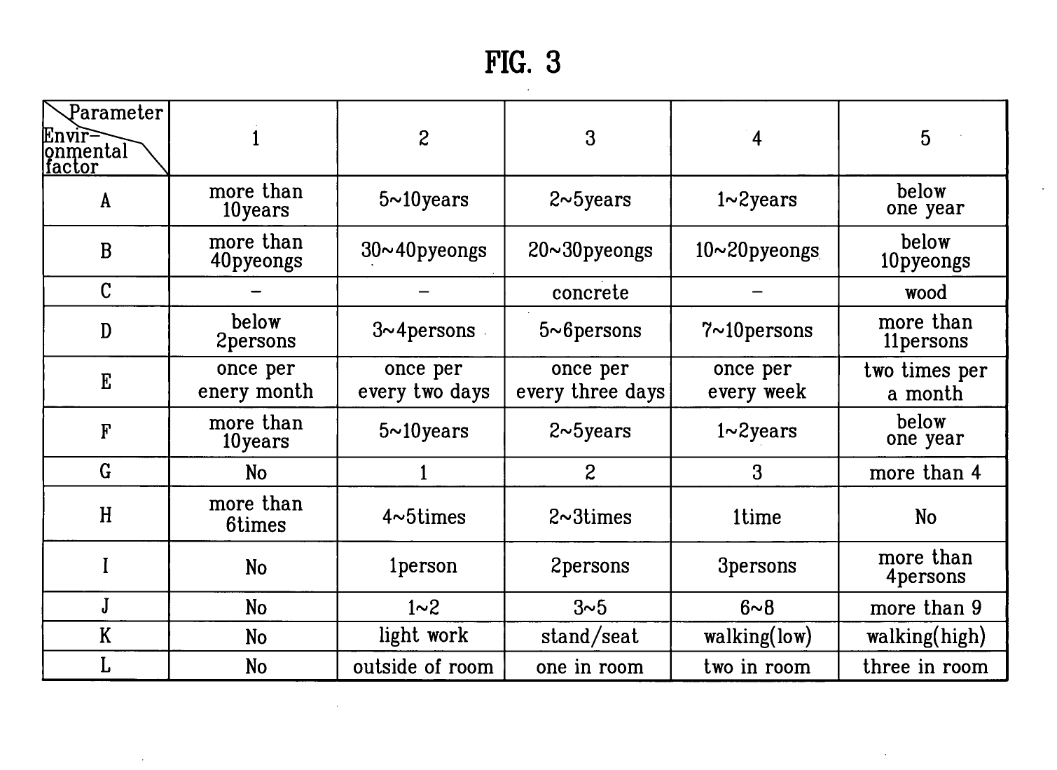

Referring to FIG. 3, the lookup table in the memory unit 60 has a plurality of environmental factor items, and parameters assigned to each of the detailed items of each of the environmental factor items.

The plurality of environmental factor items are years since construction ‘A’, a room area ‘B’, construction material ‘C’, a number of people in the room ‘D’, years since purchase of furniture, a number of burning apparatus ‘G’, a ventilation frequency ‘H’, a number of smokers ‘I’, a smoking amount ‘J’, an activity amount ‘K’, and a number of pets ‘L’.

As can be noted from the parameters of environmental factors, the smaller the parameter, the better the environment. For an example, if the years since construction ‘A’ is below one year, the parameter for this is the greatest, while, if the years since construction ‘A’ is 10, the parameter for this is the smallest.

That is, if the years since construction ‘A’ is below one year, the parameter for this is set to be the greatest because the sick house syndrome can be the most intensive, while, if the years since construction ‘A’ is 10, the parameter for this is set to be the smallest because the sick house syndrome has been resolved, fully.

Of the room area ‘B’, the parameter is the greatest if the room area is below 10 pyeongs, and the parameter is the smallest if the room area is greater than 40 pyeongs. That is, the parameter is set to be the greatest if the room area is below 10 pyeongs because ventilation is difficult, and a heat load is heavy, and the parameter is set to be the smallest if the room area is greater than 40 pyeongs because ventilation is good, and a heat load is light.

The lookup table in FIG. 3 is just an embodiment of the present invention showing factors A˜L for forming an optimal environment. However, the present invention is not limited to the lookup table in FIG. 3, but the environmental factor items, the detailed items, and the parameters may be added/removed/changed as many as required depending on a actual product design.

The control unit 70 calculates an environmental index by using parameters of the environmental factors on the lookup table set up by the user, and controls the ventilating fan 40, and the air cleaning fan 50 according to the environmental index calculated thus.

The air conditioning system of the present invention includes a communication unit 80. The communication unit 80 connects the air conditioning system to an external PC, so that the PC and the keyboard can be used as a user input means, and display means.

In the foregoing air conditioning system of the present invention, the control unit 70 detects a user order received from the user input means 10, and makes the user order to be displayed on the display means 20.

Then, the control unit 70 applies the parameters of environmental factors on the lookup table set up by the user to an environmental index calculating equation, to calculate an environmental index, with reference to the lookup table in FIG. 3.

Then, the control unit 70 controls the ventilating fan 40 and the air cleaning fan 50 with reference to the environmental index and an output of the gas sensor 30, to perform optimal ventilation and air cleaning for the present residential environment.

A method for controlling an air conditioning system in accordance with a preferred embodiment of the present invention will be described.

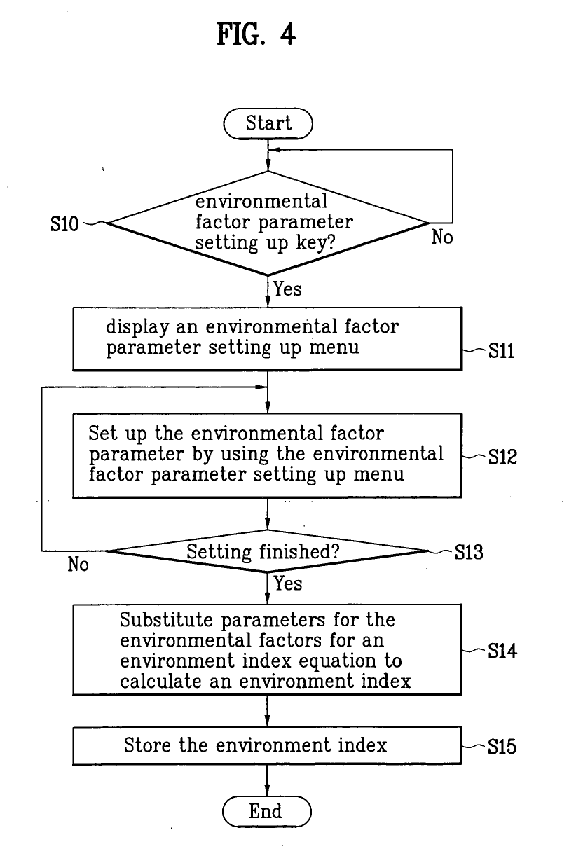

Referring to FIG. 4, a process for setting up environmental factor parameters of a residential space at an air conditioning system will be described.

The control unit 70 determines whether the user applies an environmental factor parameter setting key through the user input means 10 (S10) or not. As a result of the determination, if the environmental factor parameter setting key is applied, the control unit 70 displays an environmental factor parameter setting up menu on a display means 20 (S11).

The environmental factor parameter setting up menu has various environmental factor items, detailed items of a selected environment factor, and parameters for the detailed items.

Then, the user sets the detailed items of the various environmental factors on the environmental factor parameter setting up menu to suit to user's own residential environment (S12).

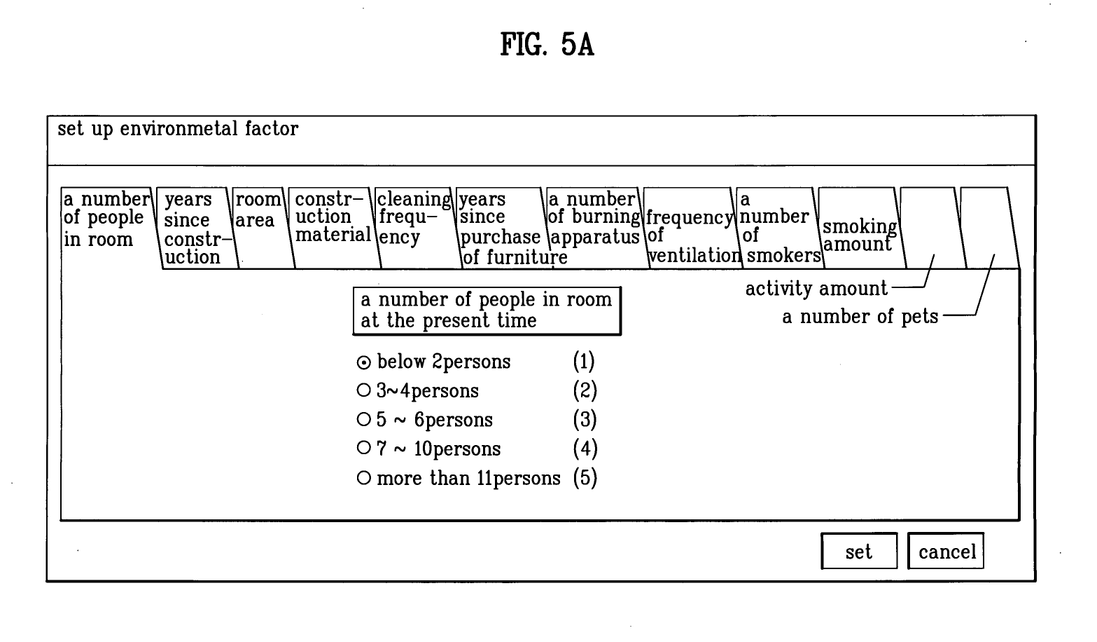

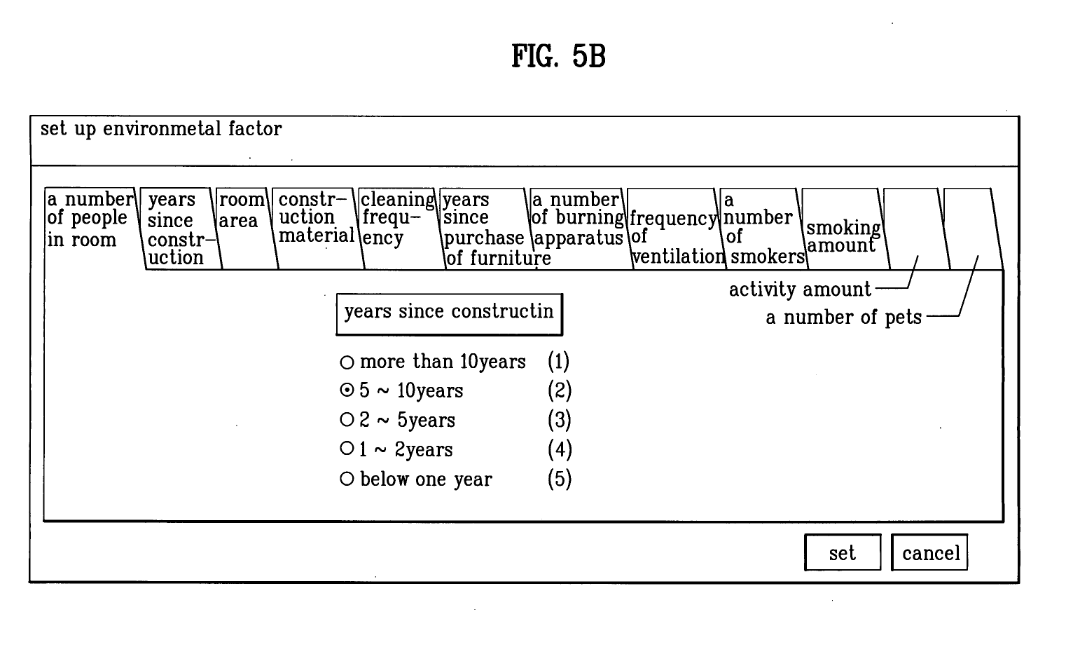

For an example, referring to FIG. 5A, if the user selects ‘people in room’ from the environmental factor items, a detailed item screen is displayed, such that the user can set a number of people in the room presently by using the user input means 10.

As another example, referring to FIG. 5B, if the user selects ‘years since construction’ from the environmental factor items, a detailed item screen is displayed, such that the user can set ‘years since construction’ of the present house by using the user input means 10.

According to above method, the user sets the environmental factors to suit to the user, such as the years since construction ‘A’, the room area ‘B’, the construction material ‘C’, a number of people in room ‘D’, the cleaning frequency ‘E’, years since purchase of furniture ‘F’, a number of burning apparatus ‘G’, a ventilating frequency ‘H’, a number of smokers ‘I’, the smoking amount ‘J’, the activity amount ‘K’, a number of pets ‘L’, and so on.

In the environmental factors, there are house environmental factors, and room environmental factors. That is, the house environmental factors are the years since construction, the room area ‘A’, and the construction material ‘C’. The room environmental factors are the people in room ‘D’, the cleaning frequency ‘E’, the years since purchase of furniture ‘F’, a number of burning apparatus ‘G’, the frequency of ventilation ‘H’, a number of smokers ‘I’, the smoking amount ‘J’, the activity amount ‘K’, and a number of pets ‘L’.

Then, the control unit 70 determines whether the environmental factor setting up is finished (S13) or not.

As a result of the determination (S13), if the user's setting of the environmental factors is finished, the control unit reads parameters for the environmental factors A/B/C/D/E/F/G/H/I/J/K/L the user set up with reference to the lookup table, and substitutes the same for the environment index equation, to obtain the environmental index (S14). The environment index equation of the present invention is defined as the following equation (1).
Environment index=A+B+C+D+E+F+G+H+I+J+K+L (1)

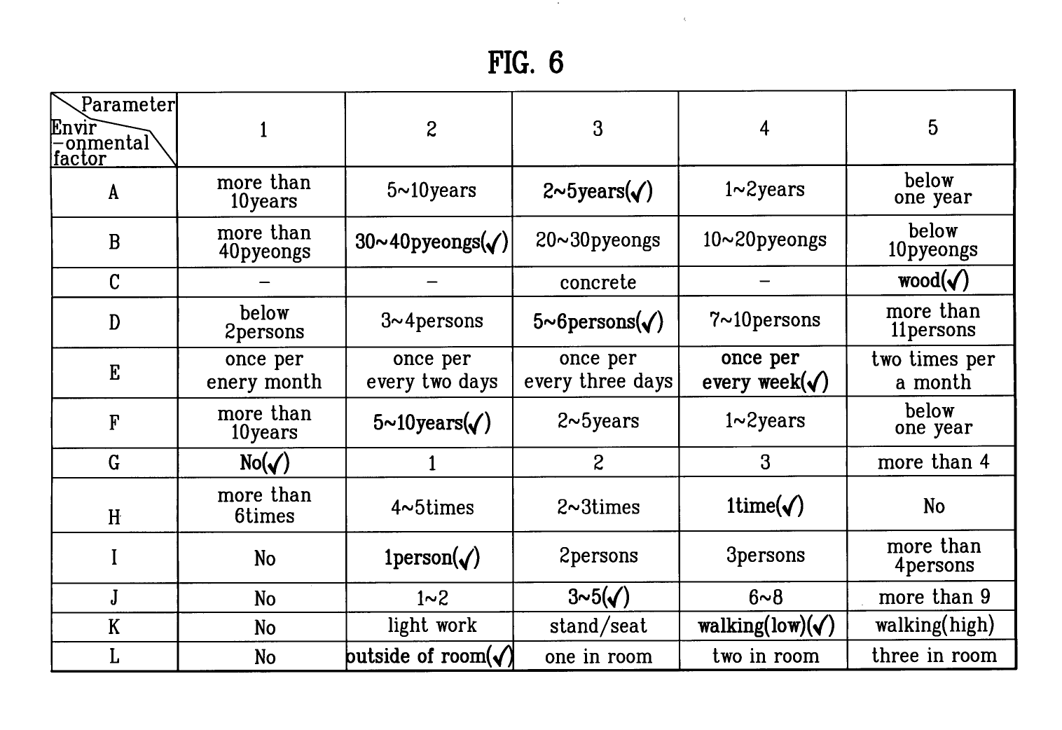

Thus, the environment index is obtained by adding up parameters for the environmental factors. For an example, if the user selects the environmental factors as shown in FIG. 6 (selected ones are marked with [symbol] ), i.e., A=3, B=2, C=5, D=5, E=4, F=2, G=1, H=4, I=2, J=3, K=4, and L=2, to obtain the environment index of 35.

In the meantime, the environment index equation may be defined as the following equation (2).
Environment index=(A*W)+(B*W)+(C*W)+(D*W)+(E*W)+(F*W)+(G*W)+(H*W)+(I*W)+(J*W)+(K*W)+(L*W) (2)

Above equation (2) calculates the environment index by applying weighted values ‘W’ different from one another to the parameters, and adding up the same.

For an example, in a case the user selects the environmental factors as shown in FIG. 6 (selected ones are marked with [symbol] ), i.e., A=3, B=2, C=5, D=5, E=4, F=2, G=1, H=4, I=2, J=3, K=4, and L=2. If it is assumed that a weighted value of (*2) is applied to each of the years since construction ‘B’, the cleaning frequency ‘E’, and the smoking amount ‘J’, and a weighted value of (*1) is applied to each of rest of the environmental factors, the environment index equation can be defined as the following equation (3).
Environment index=A+(B*2)+C+D+(E*2)+F+G+H+I+(J*2)+K+L (3)

Upon substitution of above selected environmental factor parameters for above environment index equation (3), an environment index of 44 (=3+2*2+5+3+4*2+2+1+4+2+3*2+4+2) is obtained. Then, the control unit 70 performs air conditioning operation according to the environment index stored in the memory unit 60.

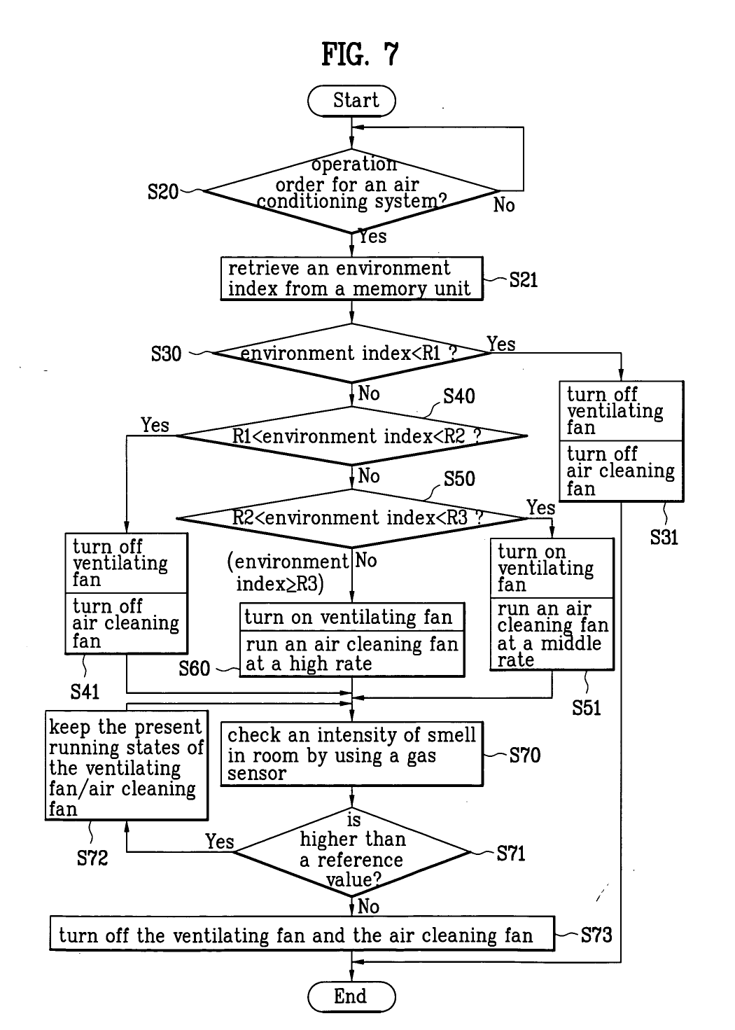

A method for controlling an air conditioning system according to the environment index will be described in more detail with reference to FIG. 7.

At first, the control unit 70 determines whether an order for operating an air conditioning system is received from a user (S20). If the order for operation of an air conditioning system is received as a result of the determination (S20), the control unit 70 retrieves the environment index from the memory unit 60 (S21).

Then, if the environment index is below a first set value R1 (S30), the control unit 70 disregards the order for operating an air conditioning system, to leave the ventilating fan 40, and the air cleaning fan 50 in turned off states (S31).

If the environment index is higher than the first set value R1, and below a second set value R2 (S40), the control unit 70 drives the air cleaning fan 50 at a low air flow rate while the ventilating fan 40 is left turned off, for cleaning air (S41).

If the environment index is higher than the second set value R2, and below a third set value R3 (S50), the control unit 70 drives the ventilating fan 40 for ventilating the room, and at the same time with this, drives the air cleaning fan 50 at a middle air flow rate, for cleaning air (S51).

If the environment index is higher than the third set value R3 (S50), the control unit 70 drives the ventilating fan 40 for ventilating the room, and at the same time with this, drives the air cleaning fan 50 at a high air flow rate, for cleaning air (S60).

The first set value R1, the second set value R2, and the third set value R3 are reference values for determining user's sense of comfortability (for an example, very comfortable/comfortable/uncomfortable/very uncomfortable) in correspondence to the environment index.

That is, it can be determined as follows;

Very comfortable (environment index<R1),

Comfortable (R1≦environment index<R2),

Uncomfortable (R2≦environment index<R3), and

Very uncomfortable (R3≦environment index).

For an example, if it is assumed that R1=25, R2=35, and R3=45. If the environment index is 20, which is determined to be in a very comfortable state, the air conditioning system is not operated like the step S31. If the environment index is 27, which is determined to be in a comfortable state, the air conditioning system is operated at a low rate like the step S41. If the environment index is 40, which is determined to be in an uncomfortable state, ventilating as well as middle rate of air cleaning are performed like the step S51. If the environment index is 50, which is determined to be in a very uncomfortable state, ventilating as well as high rate of air cleaning are performed like the step S60.

The first to third set values are variable widely taking a product characteristic, residential environment change at the time of product design, and so on into account, and changeable after setting, too.

In the meantime, the control unit 70 detects an intensity of smell by means of the gas sensor 30 periodically during the air conditioning system operation is performed (S70).

Then, the control unit 70 keeps a state of the present air conditioning system operation (S72), if the intensity of smell detected at the gas sensor 30 is higher than a reference value (S71). Opposite to this, the control unit 70 turns off the ventilating fan 40, and the air cleaning fan 50, to proceed to a power saving mode (S73), if the intensity of smell detected at the gas sensor 30 is lower than the reference value.

The reference value, a value of a smell intensity degree suitable for a resident to feel fresh fixed by experiment, is also variable taking product characteristics and environmental conditions at the time of the product design, and changeable, later.

As has been described, the air conditioning system and method for controlling the same of the present invention have the following advantages.

First, the ventilation and air cleaning taking a variety of residential environmental factors into account to the maximum permits to maximize the sense of comfort of the user.

Second, the ventilation and air cleaning taking a house environmental factors, such as years since construction, room area, construction material, and so on, that have been failed to deal with, into account permits to minimize health hazard, such as multiple chemical sensitivity.

Third, the ventilation and air cleaning taking residential and room environmental factor parameters set by a user personally into account permits to eliminate necessity for purchasing an expensive apparatus for measuring air environment.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. An air conditioning system comprising:
user input means for setting up at least one environmental factor parameter;
display means for providing an environmental factor parameter setting up menu;
a memory unit for storing the environmental factors, and parameters for the environmental factors;
a ventilating fan for ventilating a room;
an air cleaning fan for cleaning room air; and
a control unit for calculating an environment index by using parameters of the environment factors set by the user, and controlling the ventilating fan and the air cleaning fan according to the environment index.

2. The air conditioning system as claimed in claim 1, wherein the user input means is at least one of a key panel at a body, or a remote controller.

3. The air conditioning system as claimed in claim 1, wherein the user input means further includes a PC (Personal Computer).

4. The air conditioning system as claimed in claim 1, wherein the display means is provided to at least one of the body or the remote controller.

5. The air conditioning system as claimed in claim 1, wherein the display means further includes a monitor, additionally.

6. The air conditioning system as claimed in claim 1, wherein the memory unit has a lookup table therein for defining environmental factors and parameters.

7. The air conditioning system as claimed in claim 6, wherein the lookup table includes environmental factor items, detailed items of the environmental factor items, and parameters for the detailed items.

8. The air conditioning system as claimed in claim 7, wherein the environmental factor items include at least two selected from years since construction ‘A’, a room area ‘B’, construction material ‘C’, a number of people in the room ‘D’, years since purchase of furniture, a number of burning apparatus ‘G’, a ventilation frequency ‘H’, a number of smokers ‘I’, a smoking amount ‘J’, an activity amount ‘K’, and a number of pets ‘L’.

9. The air conditioning system as claimed in claim 7, wherein the parameters are defined differently depending on the detailed items of each of the environmental factors.

10. A method for controlling an air conditioning system, comprising the steps of:
user setting environmental factor parameters suitable to user's residential environment;
calculating an environment index by using the environmental factor parameters; and
controlling ventilation and air cleaning operation according to the environment index.

11. The method as claimed in claim 10, wherein the step of user setting environmental factor parameters includes the steps of;
displaying a setting menu of the environmental factor parameters according to a user's order,
setting the environmental factor parameters on the setting menu to suit to a user's residential environment, and
storing an environmental factor parameter set state.

12. The method as claimed in claim 11, wherein the setting up menu of the environmental factor parameter includes at least one environmental factor item, and detailed items of the environmental factor items the user selects.

13. The method as claimed in claim 12, wherein the environmental factor items include at least two selected from years since construction ‘A’, a room area ‘B’, construction material ‘C’, a number of people in the room ‘D’, years since purchase of furniture, a number of burning apparatus ‘G’, a ventilation frequency ‘H’, a number of smokers ‘I’, a smoking amount ‘J’, an activity amount ‘K’, and a number of pets ‘L’.

14. The method as claimed in claim 10, wherein the step of calculating an environment index includes the step of adding up the parameters for the environmental factors.

15. The method as claimed in claim 10, wherein the step of calculating an environment index includes the step of respectively multiplying weighted values different from one another to the parameters of the environmental factors, and adding up multiplied weighted values.

16. The method as claimed in claim 10, wherein the step of controlling ventilation and air cleaning operation includes the steps of;
performing no ventilating and air cleaning operation if the environment index is below a first set value R1,
performing no ventilating operation, and performing air cleaning operation at a first air flow rate, if the environment index is greater than the first set value R1, and below a second set value R2,
performing ventilating operation, and performing air cleaning operation at a second air flow rate, if the environment index is greater than the second set value R2, and below a third set value R3, and
performing ventilating operation, and performing air cleaning operation at a third air flow rate, if the environment index is greater than the third set value R3.

17. The method as claimed in claim 16, wherein the first set value R1 to the third set value R3 are reference values for determining a sense of comfortability of the user, defined according to the environment index.

18. The method as claimed in claim 16, wherein the first air flow rate, the second air flow rate, and the third air flow rate have relations of the first air flow rate<the second air flow rate<the third air flow rate in view of power.

19. The method as claimed in claim 10, further comprising the step of controlling the ventilating and air cleaning operation according to an intensity of smell in the room.

20. The method as claimed in claim 19, wherein the step of controlling the ventilating and air cleaning operation according to an intensity of smell in the room includes the steps of;
detecting the intensity of smell in the room periodically during the ventilating and air cleaning operation is performed according to the environment index,
keeping the present ventilating and air cleaning operation if the intensity of smell detected is higher than a preset reference value, and
stopping the present ventilating and air cleaning operation if the intensity of smell detected is lower than the preset reference value.
